(19) United States
(12) Patent Application Publication
(10) Pub. No.: US 2016/0152834 A1
(43) Pub. Date: Jun. 2, 2016

(54) DECORATIVE COATING

(71) Applicant: TOYOTA JIDOSHA KABUSHIKI KAISHA, Toyota-shi (JP)

(72) Inventor: Fumitaka YOSHINAGA, Toyota-shi (JP)

(73) Assignee: TOYOTA JIDOSHA KABUSHIKI KAISHA, Toyota-shi (JP)

(21) Appl. No.: 14/952,164

(22) Filed: Nov. 25, 2015

(30) Foreign Application Priority Data
Nov. 28, 2014 (JP) 2014-241868
Apr. 17, 2015 (JP) 2015-085025

(51) Int. Cl. C09D 5/00; C09D 7/12; C09D 133/14; C08J 7/04

(52) U.S. Cl. CPC C09D 5/00; C08J 7/047; C09D 7/1216; C09D 133/14; C08J 2300/00; C08J 2433/14; C08K 2003/0806

(57) ABSTRACT

Provided is a decorative coating which is formed on a surface of a resin substrate placed on a path of electromagnetic waves of a radar device. The decorative coating includes at least: fine particles of silver or a silver alloy that are dispersed in the decorative coating; and a light-transmissive binder resin that binds the fine particles. In this decorative coating, in the CIE 1976 (L*, a*, b*) color space, a chromaticness index a* and a chromaticness index b* of the decorative coating satisfy a relationship of 6.7≦((a*)²+(b*)²)^{1/2}≦23.4.

### INCORPORATION BY REFERENCE

The disclosure of Japanese Patent Application No. 2014-241868 and 2015-085025 filed on Nov. 28, 2014 and Apr. 17, 2015 including the specification, drawings and abstract is incorporated herein by reference in its entirety.

### BACKGROUND OF THE INVENTION

1. Field of the Invention

The present invention relates to a decorative coating that is provided on a surface of a resin substrate and particularly to a decorative coating having excellent gloss.

2. Description of Related Art

In the related art, in a vehicle such as an automobile, a radar device such as a millimeter-wave radar is mounted at the center of the front of the vehicle to measure the distance to an obstacle ahead of the vehicle or the distance to the preceding vehicle. Electromagnetic waves such as millimeter waves from the radar device are directed forward through the front grill and vehicle-manufacturer emblem and reflected by an object such as a preceding vehicle or an obstacle ahead, and the reflected waves return to the radar device through the front grill.

Thus, it is preferred that a material or coating material which causes little radio-wave transmission loss and can provide desired good appearance is used for the portions of the front grill, emblem, and the like which are placed on a beam path of the radar device. Therefore, typically, a decorative coating is formed on a surface of a resin substrate.

On the other hand, in the related art, a silver coating has high visible light reflectance and excellent infrared light shielding properties and thus are used for various applications. Further, due to its excellent electromagnetic wave shielding properties, for example, the silver coating can protect electronic apparatuses, which malfunction due to electromagnetic waves, from external electromagnetic waves or can suppress radiation of electromagnetic waves generated from electronic apparatuses. Therefore, the silver coating may be used as an electromagnetic wave shielding coating.

For example, Japanese Patent Application Publication No. 2004-263290 (JP 2004-263290 A) discloses a silver alloy coating for electromagnetic wave shielding containing 0.01 at % to 10 at % of bismuth (Bi) and/or antimony (Sb). On this silver alloy coating for electromagnetic wave shielding, a transparent dielectric coating is formed, and even if the silver alloy coating is directly exposed to air through a defect such as a pinhole or a scratch formed on the coating, aggregation of silver is not likely to occur.

However, when silver is used on a surface of a resin substrate, such as the emblem, that is placed on a path of electromagnetic waves of a radar device in order to enhance the design, for example, when a silver coating is coated on the resin substrate as disclosed in JP 2004-263290 A, it is difficult for electromagnetic waves such as millimeter waves radiated from a radar device to pass through the resin substrate.

A configuration can be conceived from the above finding in which, for example, fine particles of silver or a silver alloy and a binder resin for binding the silver fine particles are coated on the substrate surface as a decorative coating. However, when such a decorative coating is used over time, the decorative coating is exposed to light (is affected by light energy). At this time, the gloss of the decorative coating is not substantially changed.

### SUMMARY OF THE INVENTION

According to the invention, it is possible to provide a decorative coating that is provided on a surface of a resin substrate placed on a path of electromagnetic waves of a radar device, in which the gloss of the decorative coating can be improved when fine particles of silver or a silver alloy are used.

As a result of thorough investigation, the present inventors have found that the gloss of a decorative coating is improved by surface plasmon resonance absorption on fine particles of silver or a silver alloy and a surface of a binder resin for binding the fine particles. That is, as shown in FIG. 7A, when a decorative coating is irradiated with light, a binder resin for binding fine particles of silver or a silver alloy (metal fine particles) vibrate together with the fine particles due to the light energy. As a result, free electrons in the fine particles of silver and the silver alloy move, and thus it is considered that the fine particles of silver and the silver alloy are likely to be polarized.

In this way, as illustrated in FIG. 7B, surface electromagnetic waves called surface plasmon polariton are generated on fine particles of silver or a silver alloy and a surface of a binder resin and absorb light in a specific wavelength range. Accordingly, the energy of, in particular, the fine particles of silver or a silver alloy is likely to be amplified (surface plasmon resonance absorption).

As a result, the present inventors have newly found: the amplified energy is likely to affect a material forming the peripheries of the fine particles of silver or a silver alloy and improves the gloss of the decorative coating. For example, one of the reasons for this is that the fine particles are densified by the material forming the peripheries of the fine particles being modified. Accordingly, the present inventors have thought that, in order to improve the gloss of a decorative coating, it is important to select a combination of fine particles of silver or a silver alloy where surface plasmon resonance absorption is likely to occur and a binder resin and have also thought that the hue of the decorative coating contributes to surface plasmon resonance absorption with the above-described combination.

According to a first aspect of the invention, there is provided a decorative coating which is provided on a surface of a resin substrate placed on a path of electromagnetic waves of a radar device. The decorative coating includes: fine particles of silver or a silver alloy that are dispersed in the decorative coating; and a light-transmissive binder resin that binds the fine particles. In this decorative coating, in the CIE 1976 (L*, a*, b*) color space, a chromaticness index a* and a chromaticness index) b* of the decorative coating satisfy a relationship of 6.7≦((a*)²+(b*)²)^{1/2}≦23.4.

The decorative coating includes at least: fine particles of silver or a silver alloy that are dispersed in the decorative coating; and a light-transmissive binder resin that binds the fine particles. As a result, the decorative coating has metallic gloss in appearance and has electromagnetic wave transmitting properties (electric insulating properties).

In the CIE 1976 (L*, a*, b*) color space, as the chromaticness indices a* and b* approach 0, the color of the decorative coating approaches achromatic color. On the other hand, as the value of the chromaticness index a* increases from 0, the hue of the decorative coating approaches red. As the value of the chromaticness index a* decreases from 0, the hue of the decorative coating approaches green. Further, as the value of the chromaticness index b* increases from 0, the hue of the decorative coating approaches yellow. As the value of the chromaticness index b* decreases from 0, the hue of the decorative coating approaches blue.

In the embodiment, the chromaticness index a* and the chromaticness index b* of the decorative coating satisfy a relationship of 6.7≦((a*)²+(b*)²)^{1/2}≦23.4. Therefore, the decorative coating exhibits a color (chromatic color) where surface plasmon resonance absorption, which is a unique characteristic of the fine particles of silver or a silver alloy, is likely to occur. As a result, in an environment where light is irradiated, the degree to which the metallic gloss increases in the decorative coating increases over time.

On the other hand, when the chromaticness index a* and the chromaticness index b* of the decorative coating satisfy a relationship of ((a*)²+(b*)²)^{1/2}<6.7, the value of ((a*)²+(b*)²)^{1.2} is low, and the color of the decorative coating approaches an achromatic color. As a result, since surface plasmon resonance absorption, which is a unique characteristic of the fine particles of silver or a silver alloy, is suppressed (light energy is not likely to be absorbed), the gloss of the decorative coating is not substantially changed. As can be clearly seen from Examples described below, currently, a decorative coating can be manufactured in which the chromaticness index a* and the chromaticness index b* satisfies a relationship of ((a*)²+(b*)²)^{1/2}≦23.4.

An average particle size of the fine particles of silver or a silver alloy may be 2 nm to 200 nm. It is known that, when the average particle size of the fine particles of silver or a silver alloy is more than 200 nm, the fine particles of silver or a silver alloy are likely to aggregate, which is likely to decrease silver gloss. As a result, the range of the average particle size of silver or the silver alloy may be defined as 200 nm or less. In addition, when the average particle size of the fine particles of silver or a silver alloy is less than 2 nm, light incident on the decorative coating is not likely to be reflected. In particular, since the fine particles of silver or a silver alloy is nanometer size, light is likely to be absorbed by a phenomenon called localized surface plasmon resonance absorption.

Further, a crystallite size of silver or a silver alloy forming the fine particles may be in a range of 2 nm to 98 nm. When the crystallite size is less than 2 nm, light incident on the decorative coating is not likely to be reflected. On the other hand, when the crystallite size is more than 98 nm, electromagnetic waves are not likely to pass through the decorative coating.

According to the invention, in a decorative coating that is provided on a surface of a resin substrate placed on a path of electromagnetic waves of a radar device, the gloss of the decorative coating can be improved over time when fine particles of silver or a silver alloy are used.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram showing a decorative coating according to an embodiment of the invention;

FIG. 2 is a schematic diagram showing a configuration of the decorative coating shown in FIG. 1;

FIG. 3 is a schematic diagram of a vehicle showing a relationship between a front grill (resin substrate) at the front of a vehicle, an emblem that is placed on the surface of the front grill, and a radar device that is located behind the resin substrate in the vehicle;

FIG. 4 is a sectional view showing a relationship between the front grill (resin substrate) at the front of the vehicle, the emblem that is placed on the surface of the front grill, and the radar device that is located behind the resin substrate in the vehicle;

FIG. 5 is a diagram showing a relationship between ((a*)²+(b*)²)^{1/2} and a gloss increase.

FIG. 6 is a diagram showing a relationship between wavelengths of light incident on decorative coatings according to Example 2 and Comparative Example 1 and reflectance values of the decorative coatings;

FIG. 7A is a diagram showing states of fine particles of a silver alloy until being polarized by light; and

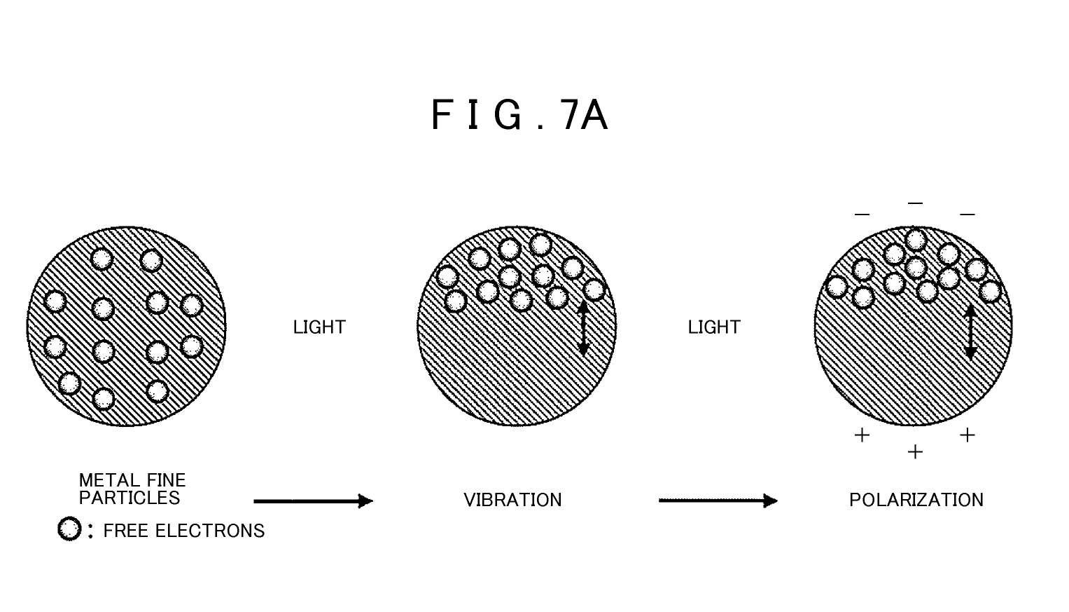

FIG. 7B is a diagram showing surface plasmon resonance absorption.

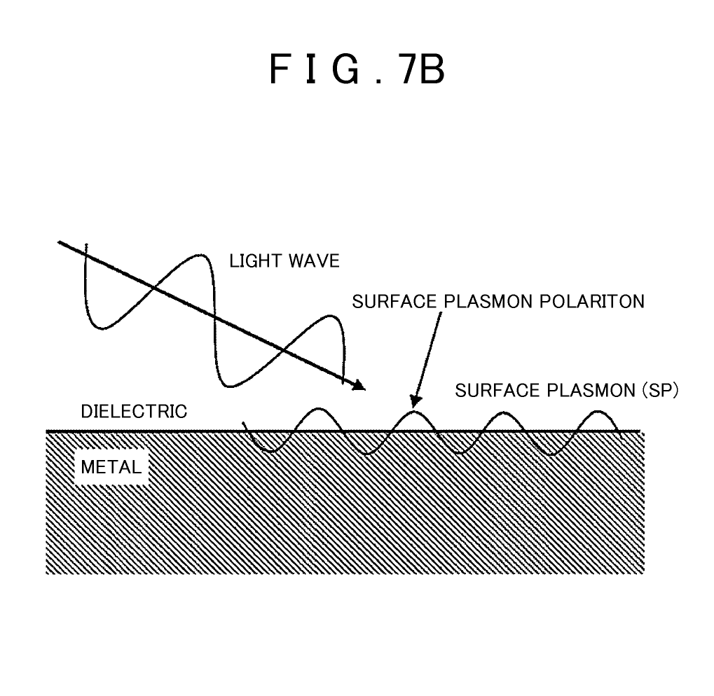

### DETAILED DESCRIPTION OF EMBODIMENTS

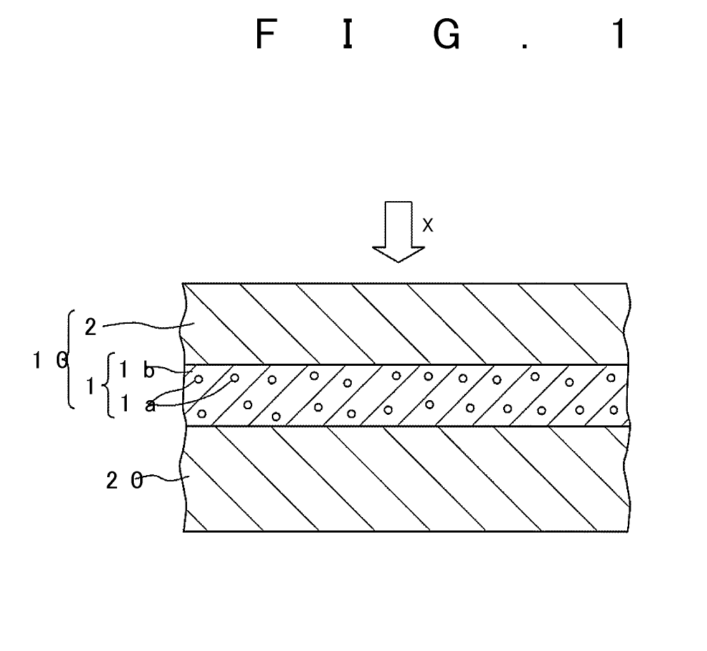

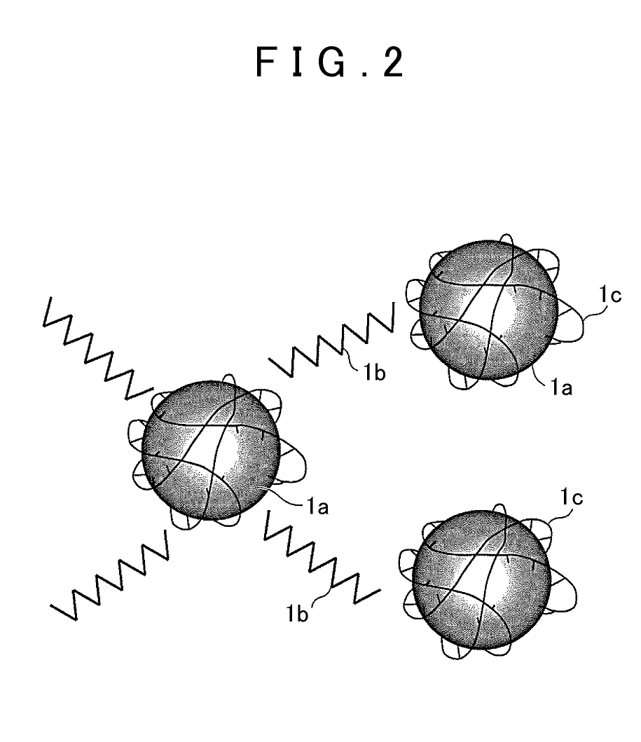

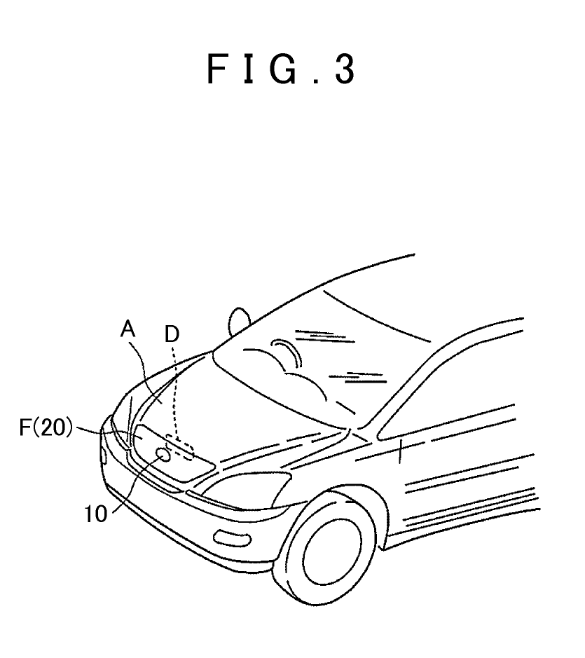

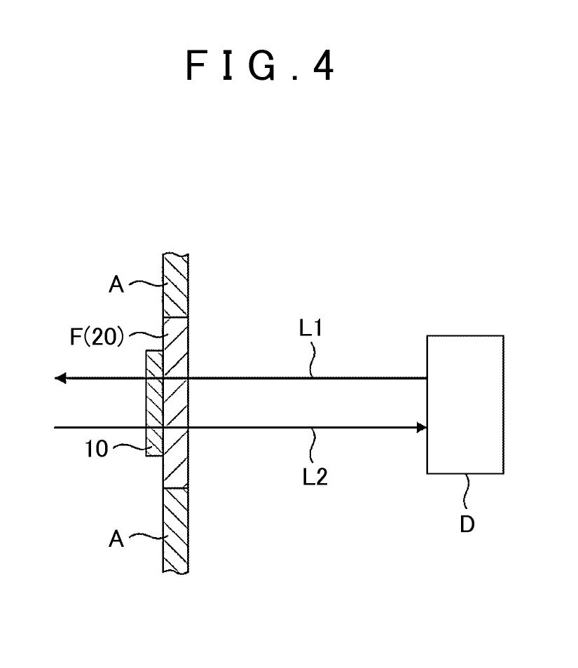

Hereinafter, embodiments of the invention will be described with reference to the drawings. FIG. 1 is a schematic diagram showing a decorative coating 1 according to an embodiment of the invention. FIG. 2 is a schematic diagram showing a configuration of the decorative coating 1 shown in FIG. 1. FIG. 3 is a schematic diagram of a vehicle showing a relationship between a front grill F (resin substrate 20) at the front of a vehicle, an emblem 10 that is placed on the surface of the front grill, and a radar device D that is located behind the front grill F in the vehicle. FIG. 4 is a sectional view showing a relationship between the front grill F (resin substrate 20) at the front of the vehicle, the emblem 10 that is placed on the surface of the front grill, and the radar device D that is located behind the front grill F in the vehicle.

The decorative coating 1 shown in FIG. 1 forms a part of an emblem 10 mounted on a surface of the resin substrate 20 which is the front grill F. As shown in FIG. 3, the radar device D provided at the front of a vehicle body A is located behind the front grill F.

As shown in FIG. 4, millimeter waves L1 that are emitted from the radar device D are directed forward through the front grill F and the emblem 10 placed on the front grill F. The directed millimeter waves L1 are reflected by an object such as a preceding vehicle or an obstacle ahead. The millimeter waves L2 return to the radar device D through the emblem 10 and the front grill F. Accordingly, the emblem 10 including the decorative coating 1 is formed on the surface of the resin substrate 20 that is placed on a path of electromagnetic waves of the radar device.

Since the decorative coating 1 is formed on the surface of the resin substrate 20 (front grill F) placed on a path of electromagnetic waves of a radar device, the decorative coating 1 has metallic gloss in appearance and has electromagnetic wave transmitting properties (electric insulating properties).

Specifically, as shown in FIG. 1, a colorless transparent resin coating layer 2 is laminated on the decorative coating 1 in a visual recognition direction (X direction) to form the emblem 10. An adhesive sheet or the like is bonded to the decorative coating 1. Alternatively, an adhesive seal may be bonded to the resin substrate 20.

As shown in FIG. 2, the decorative coating 1 includes at least: fine particles 1a of silver or a silver alloy that are dispersed in the decorative coating; and a light-transmissive binder resin 1b that binds the fine particles 1a of silver or a silver alloy. It is preferable that the decorative coating 1 further include a dispersant (protective agent) 1c in order to improve the dispersibility of the fine particles 1a of silver or a silver alloy.

In this way, in the decorative coating 1, the fine particles 1a of silver or a silver alloy are discontinuously dispersed in the layer. Since the distance between the fine particles 1a of silver or a silver alloy is extremely short, the particles densely aggregate. Accordingly, the particles provide metallic gloss as seen by human eyes, and when electromagnetic waves pass through individual nanoparticles, millimeter wave loss is extremely small in the electromagnetic waves. As a result, the decorative coating 1 has metallic gloss in appearance and has electric insulating properties.

The term “millimeter waves” described in this specification refers to electromagnetic waves in a frequency band of approximately 30 GHz to 300 GHz among electromagnetic waves. For example, electromagnetic waves with a frequency of approximately 76 GHz can be specified as millimeter waves. In addition, the term “decorative coating” described in this specification refers to a component included in the above-described vehicle-manufacturer emblem or a decoration unique to the vehicle. The emblem or the like which is formed of the decorative coating or includes the decorative coating as a part thereof is formed on the surface of the front grill which is the resin substrate.

In this decorative coating 1 according to the embodiment, in the CIE 1976 (L*, a*, b*) color space, a chromaticness index a* and a chromaticness index b* of the decorative coating 1 satisfy a relationship of 6.7≦((a*)²+(b*)²)^{1/2}≦23.4.

Therefore, the decorative coating 1 exhibits a color (chromatic color) where surface plasmon resonance absorption, which is a unique characteristic of the fine particles 1a of silver or a silver alloy, is likely to occur. As a result, due to light which is emitted over time, the degree to which the metallic gloss increases in the decorative coating 1 increases. As the size of the fine particles of silver or a silver alloy decreases, the value of ((a*)²+(b*)²)^{1/2} increases. As the density (that is, content) of the fine particles 1a of a silver alloy increases, the value of ((a*)²+(b*)²)^{1/2} increases. Further, in the case of the fine particles 1a of a silver alloy, silver contributes to surface plasmon resonance absorption. Therefore, as the silver content in the fine particles 1a increases, the value of ((a*)²+(b*)²)^{1/2} increases. Accordingly, in order to obtain the decorative coating 1 satisfying 6.7≦((a*)²+(b*)²)^{1/2}≦23.4, the values of the above-described factors may be adjusted.

When the chromaticness index a* and the chromaticness index b* of the decorative coating satisfy a relationship of ((a*)²+(b*)²)^{1/2}<6.7, the value of ((a*)²+(b*)²)^{1/2} is low, and the color of the decorative coating approaches an achromatic color. As a result, since surface plasmon resonance absorption, which is a unique characteristic of the fine particles of silver or a silver alloy is suppressed (light energy is not likely to be absorbed), the gloss of the decorative coating is not substantially changed, irrespective of the irradiation time of light energy. On the other hand, it is difficult to manufacture a decorative coating in which the chromaticness index a* and the chromaticness index b* satisfy a relationship of ((a*)²+(b*)²)^{1/2}<23.4.

The value of ((a*)²+(b*)²)^{1/2} of the decorative coating 1 can be experimentally set, for example, by the following means of: (1) adjusting the content of the fine particles of silver or a silver alloy in the decorative coating 1 with respect to the amount of the dispersant; (2) in the case of silver alloy fine particles, adjusting metal for alloying silver and the amount thereof; and (3) selecting the kind of a binder resin and a heat treatment temperature described below.

When the fine particles are formed of silver or a silver alloy, by increasing the amount of the dispersant, aggregation between the fine particles formed of silver or a silver alloy is suppressed, the dispersibility of the fine particles in the decorative coating 1 is improved, and the amplified energy is likely to affect a material forming the peripheries of the fine particles of silver or a silver alloy and can improve the gloss of the decorative coating 1. In the embodiment, the amount of the dispersant is preferably 7.2 mass % with respect to the content of the fine particles. With such a composition, ((a*)²+(b*)²)^{1/2} shown in the embodiment is likely to be within the above-described range, and the gloss of the decorative coating 1 can be improved. A change in the gloss of the decorative coating 1 is highly dependent on the value of ((a*)²+(b*)²)^{1/2}. This is because surface plasmon resonance absorption contributes to a change in gloss. The change in the gloss of the decorative coating 1 is not dependent on the lightness index L*, and the range of L* is preferably within a range of 98 to 20.

The term “fine particles” of the silver alloy described in the embodiment refers to “nanoparticles”. “Nanoparticles” refers to particles having an average particle size on the nano scale. Examples of a method of measuring a particle size of nanoparticles include a method including: extracting fine particles from a predetermined range of a SEM image or a TEM image; and obtaining an average value of particle sizes thereof as an average particle size. In particular, since the fine particles 1a of silver or a silver alloy have a nanometer size, the decorative coating is likely to absorb light energy due to surface plasmon resonance absorption.

In the embodiment, an average particle size of the fine particles 1a of silver or a silver alloy is preferably 2 nm to 200 nm. When the average particle size of the fine particles of silver or a silver alloy is more than 200 nm, the fine particles of the silver alloy are likely to cause diffused reflection, which is likely to decrease silver gloss. In addition, when the average particle size of the fine particles of a silver alloy is less than 2 nm, light incident on the decorative coating is not likely to be reflected.

Further, a crystallite size of silver or a silver alloy forming the fine particles is preferably in a range of 2 nm to 98 nm. When the crystallite size is less than 2 nm, light incident on the decorative coating is not likely to be reflected. On the other hand, when the crystallite size is more than 98 nm, electromagnetic waves are not likely to pass through the decorative coating.

For example, the fine particles of a silver alloy can be prepared, for example, by adding a reducing agent to a metal solution in which silver and a metal for alloying silver are present in the ionic state. The fine particles obtained using this preparation method are nanoparticles.

In addition, by changing the content of each metal contained in the metal solution, the composition ratio of silver and the metal for alloying the silver in the alloy can be adjusted. By adjusting the content of the dispersant, the stirring time, or the heating temperature during stirring after adding the reducing agent and the dispersant to the metal solution, the average particle size of the particles of silver or a silver alloy and the crystallite size of the silver alloy can be adjusted.

The resin coating layer 2 and the binder resin 1b are polymeric resins having light permeability, and examples of the polymeric resins include acrylic resins, polycarbonate resins, polyethylene terephthalate resins, epoxy resins, and polystyrene resins.

In addition, during the addition of the dispersant (protective agent) 1c, it is preferable that the dispersant (protective agent) 1c is a resin having high adhesiveness with the fine particles 1a of silver or a silver alloy and a high affinity for the binder resin 1b. When one of the above described exemplary resins is selected as the binder resin, it is preferable that the resin has a carbonyl group. For example, when an acrylic resin is selected as the binder resin 1b, it is preferable that an acrylic resin having a carbonyl group is selected as the dispersant (protective agent) 1c.

In this way, by the dispersant (protective agent) having a carbonyl group, the adhesiveness to the fine particles 1a of silver or a silver alloy can be improved. Further, by selecting the same resin as the binder resin 1b, the affinity of the dispersant for the binder resin 1b can be improved.

The content of the fine particles 1a of silver or a silver alloy with respect to the total mass of the decorative coating 1 is preferably 85 mass % to 99 mass %. Here, when the content of the fine particles 1a is lower than 85 mass %, metal gloss obtained by the fine particles 1a of silver or a silver alloy may not be sufficient. When the content of the fine particles 1a is higher than 99 mass %, the binding of the binder resin to the substrate may not be sufficient.

Hereinafter, the invention will be described using Examples.

### EXAMPLE 1

### Ag—Bi Alloy Fine Particles

220 g of silver nitrate and 3.3 g of bismuth nitrate were mixed with each other, 597 g of aminoalcohol (reducing agent) and 80 g of DISPERBYK 190 (dispersant: manufactured by BYK-Chemie Japan K.K.) were added thereto, and the components were heated and mixed with each other at 60° C. for 120 minutes. As a result, Ag—Bi alloy fine particles were deposited and were ultrafiltered through an ultrafiltration membrane (UF membrane) at room temperature for 3 hours. The average particle size of the obtained Ag—Bi alloy fine particles was 16 nm, the crystallite size of the Ag—Bi alloy was 14 nm, and the content of bismuth was 2.4 mass % with respect to the Ag—Bi alloy.

Next, a compounding agent was prepared which was obtained by mixing 40 g of propylene glycol monoethyl ether, 8.86 g of styrene, 8.27 g of ethylhexyl acrylate, 15 g of lauryl methacrylate, 34.8 g of 2-hydroxyethyl methacrylate, 3.07 g of methacrylic acid, 30 g of acid phosphoxyhexa monomethacrylate, 43 g of a polymerization initiator of propylene glycol monoethyl ether, and 0.3 g of tertiary butyl peroctoate.

0.38 g of DISPERBYK 190 (manufactured by BYK-Chemie Japan K.K.), 0.23 g of EPOCROS WS-300 (manufactured by Nippon Shokubai Co., Ltd.), 0.09 g of BYK-330 (manufactured by BYK-Chemie Japan K.K.), and 150 g of 1-ethoxy-2-propanol were mixed with 0.465 g of compounding agent to prepare a coating material. The Ag—Bi alloy fine particles were mixed with the coating material as a binder resin such that the content of the Ag—Bi alloy fine particles was 5 mass % with respect to the total amount of the coating. Next, the obtained mixture was applied using a spin coater, followed by a heat treatment at 80° C. for 30 minutes to form a decorative coating. The Ag—Bi alloy fine particles were mixed with the binder resin such that the content of the Ag—Bi alloy fine particles was 95 mass % with respect to the total amount of the decorative coating.

### EXAMPLE 2

### Ag Fine Particles

A decorative coating was formed with the same method as in Example 1. Example 2 was different from Example 1, in that: Ag fine particles formed of silver were prepared without the addition of bismuth nitrate; and the amount of the dispersant was decreased. Specifically, during the preparation of Ag fine particles, 597 g of aminoalcohol (reducing agent) and 27 g of DISPERBYK 190 (dispersant: manufactured by BYK-Chemie Japan K.K.) were added to 220 g of silver nitrate, and the components were heated and mixed with each other at 60° C. for 120 minutes such that Ag fine particles were deposited. The deposited Ag fine particles were filtered through a UF membrane at room temperature for 3 hours. The average particle size of the obtained Ag fine particles was 19 nm, and the crystallite size of Ag was 16 nm. The Ag fine particles were mixed with the binder resin such that the content of the Ag fine particles was 95 mass % with respect to the total amount of the decorative coating.

### EXAMPLE 3

### Ag Fine Particles

A decorative coating was formed with the same method as in Example 1. Example 3 was different from Example 1, in that: Ag fine particles formed of silver were prepared without the addition of bismuth nitrate; the amount of the dispersant was decreased; the composition of the binder resin was changed; and heat treatment conditions after the formation of the decorative coating using a spin coater were changed.

Specifically, as in Example 2, during the preparation of Ag fine particles, 597 g of aminoalcohol (reducing agent) and 27 g of DISPERBYK 190 (dispersant: manufactured by BYK-Chemie Japan K.K.) were added to 220 g of silver nitrate, and the components were heated and mixed with each other at 60° C. for 120 minutes such that Ag fine particles were deposited. The deposited Ag fine particles were filtered through a UF membrane at room temperature for 3 hours. From this point of view, Example 3 is the same as Example 2.

Further, a coating material was prepared by mixing 3.16 g of Plameez WY (manufactured by Origin Electric Co., Ltd.) as a main agent, 0.72 g of Plameez WY (manufactured by Origin Electric Co., Ltd.) as a curing agent, 0.03 g of BYK-330 (manufactured by BYK-Chemie Japan K.K.), and 13.97 g of 1-ethoxy-2-propanol, and this coating material was mixed with the Ag fine particles as a binder resin. Specifically, the Ag fine particles were mixed with the binder resin such that the content of the Ag fine particles was 95 mass % with respect to the total amount of the decorative coating. The obtained mixture was applied using a spin coater, followed by a heat treatment at 80° C. for 30 minutes to form a decorative coating.

### EXAMPLE 4

### Ag—Pd Alloy Fine Particles

A decorative coating was formed with the same method as in Example 1. Example 4 was different from Example 1, in that: Ag—Pd alloy fine particles formed of an alloy between silver and palladium were prepared by using palladium nitrate instead of bismuth nitrate; and the amount of the dispersant was decreased.

Specifically, 220 g of silver nitrate and 4.0 g of palladium nitrate were mixed with each other, 597 g of aminoalcohol (reducing agent) and 27 g of DISPERBYK 190 (dispersant: manufactured by BYK-Chemie Japan K.K.) were added to the obtained mixture, and the components were heated and mixed with each other at 60° C. for 120 minutes such that Ag—Pd alloy fine particles were deposited. The deposited Ag fine particles were filtered through a UF membrane at room temperature for 3 hours.

The average particle size of the obtained Ag—Pd alloy fine particles was 21 nm, the crystallite size of the Ag—Pd alloy was 18 nm, and the content of palladium was 1.0 mass % with respect to the Ag—Pd alloy. The Ag—Pd alloy fine particles were mixed with the binder resin such that the content of the Ag—Pd alloy fine particles was 95 mass % with respect to the total amount of the decorative coating.

### EXAMPLE 5

### Ag Fine Particles

A decorative coating was formed with the same method as in Example 1. Example 5 was different from Example 1, in that: Ag fine particles formed of silver were prepared without the addition of bismuth nitrate; and the amount of the dispersant was increased. Specifically, during the preparation of Ag fine particles, 597 g of aminoalcohol (reducing agent) and 108 g of DISPERBYK 190 (dispersant: manufactured by BYK-Chemie Japan K.K.) were added to 220 g of silver nitrate, and the components were heated and mixed with each other at 60° C. for 120 minutes such that Ag fine particles were deposited. The deposited Ag fine particles were filtered through a UF membrane at room temperature for 3 hours. The average particle size of the obtained Ag fine particles was 19 nm, and the crystallite size of Ag was 16 nm. The Ag fine particles were mixed with the binder resin such that the content of the Ag alloy fine particles was 95 mass % with respect to the total amount of the decorative coating.

### COMPARATIVE EXAMPLE 1

### Ag—Ni Alloy Fine Particles

A decorative coating was formed with the same method as in Example 1. Comparative Example 1 was different from Example 1, in that: Ag—Ni alloy fine particles formed of an alloy between silver and nickel were prepared by using nickel nitrate instead of bismuth nitrate; and the amount of the dispersant was decreased.

Specifically, 220 g of silver nitrate and 16 g of nickel nitrate were mixed with each other, 597 g of aminoalcohol (reducing agent) and 27 g of DISPERBYK 190 (dispersant: manufactured by BYK-Chemie Japan K.K.) were added to the obtained mixture, and the components were heated and mixed with each other at 60° C. for 120 minutes such that Ag—Ni alloy fine particles were deposited. The deposited Ag—Ni alloy fine particles were filtered through a UF membrane at room temperature for 3 hours.

The average particle size of the obtained Ag—Ni alloy fine particles was 35 nm, the crystallite size of the Ag—Ni alloy was 30 nm, and the content of nickel was 5.1 mass % with respect to the Ag—Ni alloy. The Ag—Ni alloy fine particles were mixed with the binder resin such that the content of the Ag—Ni alloy fine particles was 95 mass % with respect to the total amount of the decorative coating.

### COMPARATIVE EXAMPLE 2

### Ag—Ni Alloy Fine Particles

A decorative coating was formed with the same method as in Example 1. Comparative Example 2 was different from Example 1, except that: Ag—Ni alloy fine particles formed of an alloy between silver and nickel were prepared by using nickel nitrate instead of bismuth nitrate; and the amount of the dispersant was decreased.

Specifically, 220 g of silver nitrate and 64 g of nickel nitrate were mixed with each other, the obtained mixture was added to 597 g of aminoalcohol (reducing agent) and 27 g of DISPERBYK 190 (dispersant: manufactured by BYK-Chemie Japan K.K.), and the components were heated and mixed with each other at 60° C. for 120 minutes such that Ag—Ni alloy fine particles were deposited. The deposited Ag—Ni alloy fine particles were filtered through a UF membrane at room temperature for 3 hours. The average particle size of the obtained Ag—Ni alloy fine particles was 25 nm, the crystallite size of the Ag—Ni alloy was 20 nm, and the content of nickel was 20.4 mass % with respect to the Ag—Ni alloy. The Ag—Ni alloy fine particles were mixed with the binder resin such that the content of the Ag—Ni alloy fine particles was 95 mass % with respect to the total amount of the decorative coating.

### COMPARATIVE EXAMPLE 3

### Ag—Ni Alloy Fine Particles

A decorative coating was formed with the same method as in Example 1. Comparative Example 3 was different from Example 1, in that: Ag—Ni alloy fine particles formed of an alloy between silver and nickel were prepared by using nickel nitrate instead of bismuth nitrate; the amount of the dispersant was decreased; and the composition of the binder resin was changed. Comparative Example 3 was different from Example 3, except that Ag fine particle were changed to Ag—Ni alloy fine particles.

Specifically, 220 g of silver nitrate and 16 g of nickel nitrate were mixed with each other, 597 g of aminoalcohol (reducing agent) and 27 g of DISPERBYK 190 (dispersant: manufactured by BYK-Chemie Japan K.K.) were added to the obtained mixture, and the components were heated and mixed with each other at 60° C. for 120 minutes such that Ag—Ni alloy fine particles were deposited. The deposited Ag—Ni alloy fine particles were filtered through a UF membrane at room temperature for 3 hours.

Further, a coating material was prepared by mixing 3.16 g of Plameez WY (manufactured by Origin Electric Co., Ltd.) as a main agent, 0.72 g of Plameez WY (manufactured by Origin Electric Co., Ltd.) as a curing agent, 0.03 g of BYK-330 (manufactured by BYK-Chemie Japan K.K.), and 13.97 g of 1-ethoxy-2-propanol, and this coating material was mixed with the Ag—Ni alloy fine particles as a binder resin. The Ag—Ni alloy fine particles were mixed with the binder resin such that the content of the Ag—Ni alloy fine particles was 95 mass % with respect to the total amount of the decorative coating.

### COMPARATIVE EXAMPLE 4

### Ag Fine Particles

A decorative coating was formed with the same method as in Example 1. Comparative Example 4 was different from Example 1, in that: Ag fine particles formed of silver were prepared without the addition of bismuth nitrate; the amount of the dispersant was decreased; the composition of the binder resin was changed; and heat treatment conditions after the formation of the decorative coating using a spin coater were changed. Comparative Example 4 was different from Example 3, in that a heat treatment temperature after the application using a spin coater was changed.

Specifically, 597 g of aminoalcohol (reducing agent) and 27 g of DISPERBYK 190 (dispersant: manufactured by BYK-Chemie Japan K.K.) were added to 220 g of silver nitrate, and the components were heated and mixed with each other at 60° C. for 120 minutes such that Ag fine particles were deposited. The deposited Ag fine particles were filtered through a UF membrane at room temperature for 3 hours.

Further, a coating material was prepared by mixing 3.16 g of Plameez WY (manufactured by Origin Electric Co., Ltd.) as a main agent, 0.72 g of Plameez WY (manufactured by Origin Electric Co., Ltd.) as a curing agent, 0.03 g of BYK-330 (manufactured by BYK-Chemie Japan K.K.), and 13.97 g of 1-ethoxy-2-propanol, and this coating material was mixed with the Ag fine particles as a binder resin. The Ag fine particles were mixed with the binder resin such that the content of the Ag fine particles was 95 mass % with respect to the total amount of the decorative coating. The obtained mixture was applied using a spin coater, followed by a heat treatment at 120° C. for 30 minutes to form a decorative coating.

[Weather Resistance Test (Xenon Test)]

Before a weather resistance test described below, in the CIE 1976 (L*, a*, b*) color space (JIS Z 8729), the chromaticness index a* and the chromaticness index b* of the decorative coatings according to Examples 1 to 4 and Comparative Examples 1 to 4 were measured using a color difference meter (CMS-35SP, manufactured by Murakami Color Research Laboratory Co., Ltd.). Further, the value of ((a*)²+(b*)²)^{1/2} was calculated based on the measured values. The results are shown in Table 1.

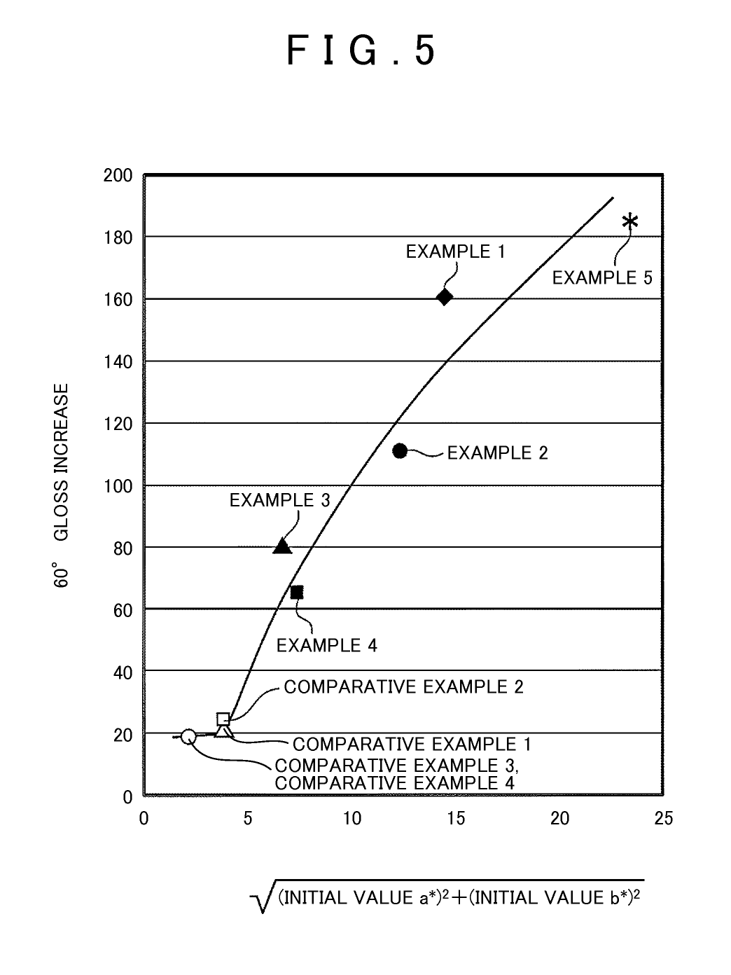

Next, according to JIS Z 8741, under a condition of a measurement angle of 60°, the gloss values of the decorative coatings according to Examples 1 to 4 and Comparative Examples 1 to 4 were measured using a gloss meter (GM-26 PRO-AUTO, manufactured by Murakami Color Research Laboratory Co., Ltd.). A weather resistance test (xenon test) was performed on the decorative coatings according to Examples 1 to 4 and Comparative Examples 1 to 4 (100 W×125 MJ). After the weather resistance test, the gloss values of the decorative coatings according to Examples 1 to 4 and Comparative Examples 1 to 4 were measured. Regarding each of Examples 1 to 4 and Comparative Examples 1 to 4, a gloss increase was calculated by subtracting the gloss value before the weather resistance test from the gloss value after the weather resistance test. The results) are shown in Table 1. FIG. 5 is a diagram showing a relationship between ((a*)²+(b*)²)^{1/2} and a gloss increase.

TABLE 1

| | Fine | Initial a* | Initial b* | | Gloss |
|---|---|---|---|---|---|
| | Particles | Value | Value | \sqrt{(a*)2 + (b*)2} | Increase |
| Example 1 | Ag—Bi | −0.3 | −14.5 | 14.5 | 160.3 |
| Example 2 | Ag | −7.9 | −9.5 | 12.3 | 110.5 |
| Example 3 | Ag | −5.2 | 4.2 | 6.7 | 80.1 |
| Example 4 | Ag—Pd | −5.7 | −4.7 | 7.4 | 65.2 |
| Example 5 | Ag | −1.39 | −23.4 | 23.4 | 183.9 |
| Comparative | Ag—Ni | 1.5 | 3.6 | 3.9 | 20.5 |
| Example 1 | | | | | |
| Comparative | Ag—Ni | −1.5 | 3.6 | 3.9 | 24.0 |
| Example 2 | | | | | |
| Comparative | Ag—Ni | −1.6 | −1.6 | 2.2 | 18.9 |
| Example 3 | | | | | |
| Comparative | Ag | 1.6 | −1.6 | 2.2 | 18.5 |
| Example 4 | | | | | |

[Measurement of Reflectance]

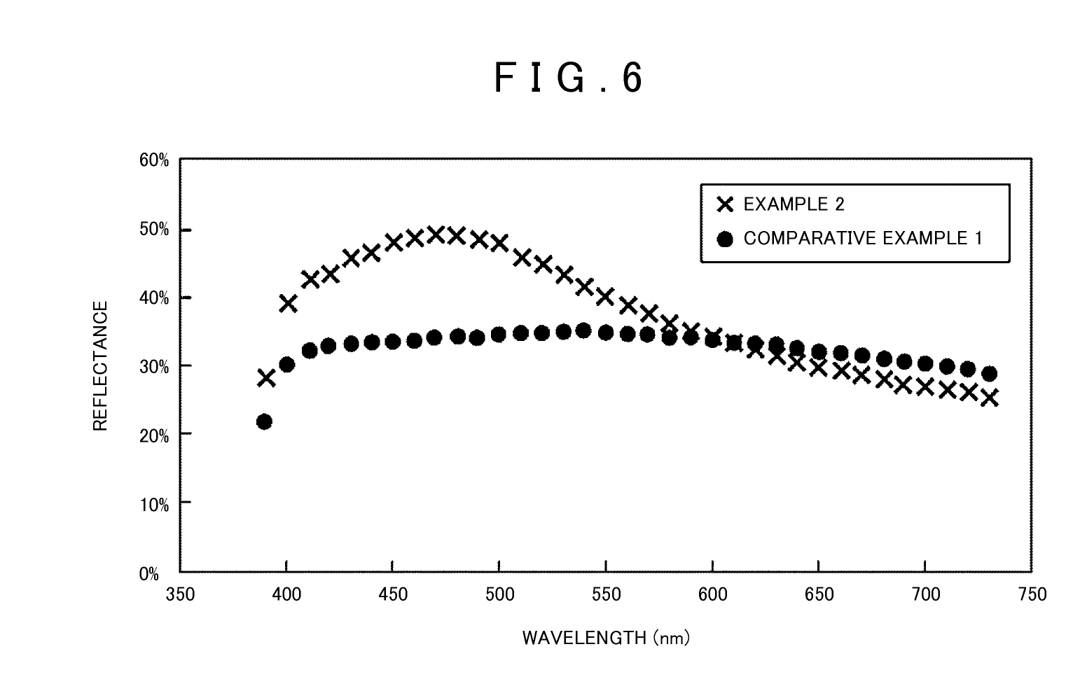

Before the weather resistance test, the decorative coatings according to Examples 2 and Comparative Examples 1 were irradiated with light, and the reflectance of the decorative coatings at each wavelength was measured from the spectra of the decorative coatings. FIG. 6 is a diagram showing a relationship between wavelengths of light incident on decorative coatings according to Example 2 and Comparative Example 1 and reflectance values of the decorative coatings.

(Result 1)

As shown in FIG. 5 and Table 1, in the decorative coatings according to Examples 1 to 5, a relationship of 6.7≦((a*)²+(b*)²)^{1/2}≦23.4 was satisfied. Within this range, the gloss increase of the decorative coating after the weather resistance test was higher than 60, and the gloss increase of the decorative coating was improved. On the other hand, the decorative coatings according to Comparative Examples 1 to 4 satisfied a relationship of ((a*)²+(b*)²)^{1/2}<6.7. Within this range, it can be said that, irrespective of the weather resistance test, the gloss of the decorative coating was not substantially changed.

Further, as shown in FIG. 6, in the decorative coating according to Example 2, the reflectance significantly changed depending on the change in wavelength as compared to Comparative Example 1. It is considered that based on the above results that, when the Ag fine particles according to Example 2 were irradiated with light, light in a specific wavelength was absorbed, and light energy absorbed on the Ag fine particles was likely to be amplified (surface plasmon resonance absorption). As a result, in Example 2, the amplified energy was likely to affect the material forming the peripheries of the silver fine particles. Therefore, it is considered that, in the decorative coating according to Example 2, the gloss after the weather resistance test was improved. It is considered that this phenomenon occurred in Examples 1, 3, 4, and 5.

It is considered from the above results that, since the chromaticness index a* and the chromaticness index b* satisfied a relationship of 6.7≦((a*)²+(b*)²)^{1/2}≦23.4, the decorative coatings according to Examples 1 to 5 exhibited a color (chromatic color) where surface plasmon resonance absorption, which was a unique characteristic of the fine particles of Ag or a Ag alloy, was likely to occur. As a result, it is considered that, in each of Examples 1 to 4, the degree to which the metallic gloss increased in the decorative coating after the weather resistance test was increased (the gloss increase was increased).

On the other hand, in the decorative coatings according to Comparative Examples 1 to 4, the value of ((a*)²+(b*)²)^{1/2} was excessively low, and the colors of the decorative coatings exhibited a color close to an achromatic color. Therefore, surface plasmon resonance absorption which was a unique characteristic of the fine particles of Ag or a Ag alloy, was suppressed. As a result, it is considered that, in Comparative Examples 1 to 4, the gloss of the decorative coatings after the weather resistance test was not substantially changed (the gloss increase was small).

### EXAMPLE 6

### Ag Fine Particles

A decorative coating was formed with the same method as in Example 1. Example 6 was different from Example 1, in that the heating temperature, the mixing time, and the concentration of the dispersant during the mixing of silver nitrate, bismuth nitrate, aminoalcohol, and the dispersant were changed such that the average particle size of the fine particles of the silver alloy (Ag—Bi alloy) was 200 nm. Silver alloy fine particle were extracted from a predetermined region of a TEM image, and an average value of particle sizes thereof were measured as an average particle size of the silver alloy fine particles.

### COMPARATIVE EXAMPLE 5

A decorative coating was formed with the same method as in Example 1. Comparative Example 5 was different from Example 1, in that the heating temperature, the mixing time, and the concentration of the dispersant during the mixing of silver nitrate, bismuth nitrate, aminoalcohol, and the dispersant were changed such that the average particle size of the fine particles of the silver alloy (Ag—Bi alloy) was 500 nm.

(Result 2)

When the decorative coatings of Example 6 and Comparative Example 5 were observed, the result was as follows. In the decorative coating of Comparative Example 5 (in which the average particle size of the fine particles was more than 200 nm), the fine particles of the silver alloy caused diffused reflection, and metal gloss was likely to decrease as compared to the decorative coating of Example 5. In consideration of the above result, the average particle size of the fine particles of silver or a silver alloy is preferably 200 nm or less. In consideration of Result 3 described below, the average particle size is preferably 2 nm or more.

### EXAMPLE 7

A decorative coating was formed with the same method as in Example 1. Example 7 was different from Example 1, in that the heating temperature, the mixing time, and the concentration of the dispersant during the mixing of silver nitrate, bismuth nitrate, aminoalcohol, and the dispersant were changed such that the crystallite size of the silver alloy (Ag—Bi alloy) was in a range of 2 nm to 98 nm (specifically, 2 nm, 36 nm, and 98 nm). The crystallite size of the silver alloy was measured by X-ray diffraction analysis defined in JIS H 7805.

### COMPARATIVE EXAMPLE 6

A decorative coating was formed with the same method as in Example 1. Comparative Example 6 was different from Example 1 is that the heating temperature and the mixing time of silver nitrate, bismuth nitrate, and aminoalcohol were changed such that the crystallite size of the silver alloy (Ag—Bi alloy) was less than 2 nm or more than 98 nm (specifically, 1 nm and 99 nm).

(Result 3) When the decorative coatings of Example 7 and Comparative Example 6 were observed, the result was as follows. In Comparative Example 6, when the crystallite size was less than 2 nm, light incident on the decorative coating was not likely to be reflected. On the other hand, in Comparative Example 6, when the crystallite size was more than 98 nm, electromagnetic waves were not likely to pass through the decorative coating. The decorative coating according to Example 7 had metallic gloss and excellent electromagnetic wave transmitting properties. In consideration of the above result, the crystallite size of silver or the silver alloy is preferably in a range of 2 nm to 98 nm.

Hereinabove, the embodiments of the invention have been described with reference to the embodiment of the invention, but specific configurations thereof are not particularly limited to the above-described embodiments.

What is claimed is:

1. A decorative coating which is provided on a surface of a resin substrate placed on a path of electromagnetic waves of a radar device, the decorative coating comprising:
fine particles of silver or a silver alloy that are dispersed in the decorative coating; and
a light-transmissive binder resin that binds the fine particles,
wherein in the CIE 1976 (L*, a*, b*) color space, a chromaticness index a* and a chromaticness index b* of the decorative coating satisfy a relationship of 6.7≦((a*)²+(b*)²)^{1/2}≦23.4.

2. The decorative coating according to claim 1, wherein
an average particle size of the fine particles is 2 nm to 200 nm.

3. The decorative coating according to claim 1, wherein
a crystallite size of silver or the silver alloy in the fine particles is within a range of 2 nm to 98 nm.
